(19) United States
(12) Patent Application Publication
(10) Pub. No.: US 2026/0112008 A1
(43) Pub. Date: Apr. 23, 2026

(54) IMAGE RESTORATION METHOD AND APPARATUS, DEVICE, MEDIUM, AND PRODUCT

(71) Applicant: Beijing Zitiao Network Technology Co., Ltd., Beijing (CN)

(72) Inventors: Huadong WU, Beijing (CN); Yunhao LI, Beijing (CN)

(21) Appl. No.: 19/360,778

(22) Filed: Oct. 16, 2025

(30) Foreign Application Priority Data
Oct. 17, 2024 (CN) 202411455955.6

(51) Int. Cl. G06T 5/80; G06T 5/50; G06V 10/25; G06V 10/98

(52) U.S. Cl. CPC G06T 5/80; G06T 5/50; G06V 10/25; G06V 10/993

(57) ABSTRACT

This application discloses an image restoration method and apparatus, device, medium, and product. The method includes: first, acquiring a target image; then, determining an abnormal region in the target image based on a segmentation result for the target image and a three-dimensional model corresponding to the target image, such that the abnormal region is used to describe distortion in the target image; then, occluding the abnormal region in the target image to obtain an occluded image, such that the occluded image contains no or as little distortion as possible; and finally, determining a restoration result for the target image based on the occluded image and the three-dimensional model, such that the restoration result contains no or as little distortion as possible.

### CROSS-REFERENCE TO RELATED APPLICATIONS

This application claims priority to Chinese Application No. 202411455955.6 filed Oct. 17, 2024, the disclosure of which is incorporated herein by reference in its entity.

### FIELD

This application relates to the technical field of data processing, particularly to an image restoration method and apparatus, a device, a medium, and a product.

### BACKGROUND

With the development of artificial intelligence (AI) technology, the application field of AI image generation technology has become increasingly widespread. For example, in some scenarios, such as a text-to-image scenario, the AI image generation technology can be used to generate a new image based on a text provided by a user. For another example, in some scenarios, such as an image-to-image scenario, the AI image generation technology can be used to generate a new image based on an image provided by the user.

### SUMMARY

This application provides an image restoration method and apparatus, a device, a medium, and a product.

This application provides an image restoration method. The method includes: acquiring a target image; determining an abnormal region in the target image based on a segmentation result for the target image and a three-dimensional model corresponding to the target image, where the segmentation result is used to describe positions of respective parts of an object in the target image, driving parameters of the three-dimensional model are determined based on the target image, an object described by the three-dimensional model is free of distortion, and the abnormal region is used to describe distortion in the target image; occluding the abnormal region in the target image to obtain an occluded image; and determining a restoration result for the target image based on the occluded image and the three-dimensional model.

In a possible implementation, a process of determining the abnormal region includes: projecting the three-dimensional model to an image space of the target image to obtain a two-dimensional image, where the two-dimensional image is used to describe a state of the object described by the three-dimensional model in a two-dimensional space; comparing a segmentation result for the two-dimensional image with the segmentation result for the target image to obtain a comparison result, where the comparison result is used to describe a difference between an object in the two-dimensional image and the object in the target image; and determining the abnormal region in the target image based on the comparison result.

In a possible implementation, the determining a restoration result for the target image based on the occluded image and the three-dimensional model includes: determining the restoration result for the target image based on the occluded image, the three-dimensional model, and a key point detection result for the target image, where the key point detection result is used to describe a pose of the object in the target image.

In a possible implementation, a process of determining the restoration result includes: projecting the three-dimensional model to the image space of the target image to obtain a two-dimensional image; and determining the restoration result for the target image based on the occluded image, the two-dimensional image, and the key point detection result.

In a possible implementation, the restoration result is determined by using an image restoration model; the image restoration model includes a first encoding module, a second encoding module, a first network, a second network, and a decoder; the first encoding module is used to acquire a feature extraction result for the key point detection result, where the feature extraction result for the key point detection result is used to represent first information carried by the key point detection result, and the first information includes a pose; the second encoding module is used to acquire a feature extraction result for the two-dimensional image, where the feature extraction result for the two-dimensional image is used to represent second information carried by the two-dimensional image, and the second information includes a body shape and a body structure; the first network is used to determine image features of the occluded image based on an image encoding result and a semantic feature extraction result for the occluded image; the second network is used to perform denoising processing based on the semantic feature extraction result for the occluded image, the image features of the occluded image, the feature extraction result for the two-dimensional image, the feature extraction result for the key point detection result, and randomly generated noise data, to obtain a denoising result; and the decoder is used to decode the denoising result to obtain the restoration result for the target image.

In a possible implementation, the restoration result is determined by using an image restoration model; and a process of training the image restoration model includes: acquiring a first image, where an object in the first image is free of distortion; randomly selecting a region from the first image for occlusion, to obtain a region occlusion result; determining a restoration result for the first image based on the image restoration model, the region occlusion result, the three-dimensional model corresponding to the first image, and the key point detection result for the first image; and updating a portion of networks within the image restoration model based on a difference between the restoration result for the first image and the first image, where the portion of the networks include a first encoding module, a second encoding module, a first network, and a second network.

In a possible implementation, a process of determining the abnormal region includes: determining first abnormal information based on the segmentation result and the three-dimensional model, and determining second abnormal information based on the segmentation result and a key point detection result for the target image, where the first abnormal information is used to describe differences between a part described by the three-dimensional model and a part described by the segmentation result, and the second abnormal information is used to describe differences between a part described by the key point detection result and the part described by the segmentation result; and determining the abnormal region in the target image based on the first abnormal information and the second abnormal information.

In a possible implementation, the key point detection result is determined by using a key point detector; and the key point detector is trained using a second image and key point label information of the second image, where an object in the second image is distortion-free, and the key point label information is used to describe an actual position of a key point of the object in the second image.

In a possible implementation, a process of determining the abnormal region includes: determining first abnormal information based on the segmentation result and the three-dimensional model, where the first abnormal information is used to describe differences between a part described by the three-dimensional model and a part described by the segmentation result; and determining the abnormal region in the target image based on the first abnormal information and an anomaly detection result for the target image, where the anomaly detection result is obtained by processing the target image using an anomaly detector, the anomaly detector is trained using a positive sample image, a negative sample image, and anomaly label information of the negative sample image, an object in the positive sample image is distortion-free, an object in the negative sample image exhibits distortion, and the anomaly label information is used to describe an actual position of distortion in the negative sample image.

In a possible implementation, after the determining the abnormal region in the target image, the method further includes: determining a screenshot of at least one region from the target image, where different regions are used to describe different parts of the object in the target image, and the at least one region does not include the abnormal region; for any region within the at least one region, performing anomaly detection processing on a screenshot of the region to obtain an anomaly detection result for the region; and updating the abnormal region in the target image based on the anomaly detection result for each region.

This application provides an image restoration apparatus, including: an acquiring unit, used to acquire a target image; a determination unit, used to determine an abnormal region in the target image based on a segmentation result for the target image and a three-dimensional model corresponding to the target image, where the segmentation result is used to describe positions of respective parts of an object in the target image, driving parameters of the three-dimensional model are determined based on the target image, an object described by the three-dimensional model is free of distortion, and the abnormal region is used to describe distortion in the target image; an occlusion unit, used to occlude the abnormal region in the target image to obtain an occluded image; and a restoration unit, used to determine a restoration result for the target image based on the occluded image and the three-dimensional model.

This application provides an electronic device. The device includes a processor and a memory. The memory is configured to store an instruction or a computer program. The processor is configured to execute the instruction or the computer program in the memory to cause the electronic device to perform the image restoration method provided in this application.

This application provides a computer-readable medium, having an instruction or a computer program stored therein, where the instruction or the computer program, when running on a device, causes the device to perform the image restoration method provided in this application.

This application provides a computer program product, which includes a computer program carried on a non-transitory computer-readable medium, where the computer program includes program code for performing the image restoration method provided in this application.

### BRIEF DESCRIPTION OF THE DRAWINGS

To more clearly describe the technical solutions in the embodiments of this application or in the related art, the accompanying drawings for describing the embodiments or the related art will be briefly described below. Apparently, the accompanying drawings in the description below show merely some embodiments recited in this application, and those of ordinary skill in the art may still derive other accompanying drawings from these accompanying drawings without creative efforts.

FIG. 1 is a flowchart of an image restoration method according to an embodiment of this application;

FIG. 2 is a schematic diagram of an image restoration flow according to an embodiment of this application;

FIG. 3 is a schematic diagram of a flow of determining an abnormal region according to an embodiment of this application;

FIG. 4 is a schematic structural diagram of an image restoration apparatus according to an embodiment of this application; and

FIG. 5 is a schematic structural diagram of an electronic device according to an embodiment of this application.

### DETAILED DESCRIPTION OF EMBODIMENTS

To make those skilled in the art better understand the solutions of this application, the technical solutions in the embodiments of this application are clearly and completely described in combination with the accompanying drawings in the embodiments of this application as below, and it is apparent that the described embodiments are merely a part rather all embodiments of this application. All other embodiments obtained by those of ordinary skill in the art based on the embodiments of this application without creative efforts shall fall within the scope of protection of this application.

When the AI image generation technology is used to generate an image including an object (e.g., a character or an animal), a new image generated through the AI image generation technology may exhibit abnormalities in the number of body parts, such as distortion issues like an abnormal limb count, and as a result, the yield of high-quality images is low.

Compared with the related art, this application at least has the following advantages:

In the technical solutions provided in this application, the target image is first acquired, such as a newly generated image through an AI image generation technology; then, the abnormal region in the target image is determined based on the segmentation result for the target image and the three-dimensional model corresponding to the target image, such that the abnormal region is used to describe the distortion in the target image; then, the abnormal region in the target image is occluded to obtain the occluded image, such that the occluded image contains no or as little distortion as possible; and finally, the restoration result for the target image is determined based on the occluded image and the three-dimensional model, such that the restoration result contains no or as little distortion as possible. Accordingly, the image quality can be improved, thereby increasing the yield of high-quality images.

Since the driving parameters of the three-dimensional model corresponding to the target image are determined based on the target image, the state (e.g., the body shape and the pose) of the object described by the three-dimensional model can closely approximate the state of the object in the target image, and the three-dimensional model can represent the body shape, the pose, and other characteristics of the object in the target image as accurately as possible. Additionally, since the object described by the three-dimensional model is free of the distortion, the three-dimensional model can represent the distribution of the respective parts of the distortion-free object in the object state described by the target image, thereby implementing distortion removal based on the image restoration processing of the three-dimensional model, to obtain the restoration result for describing the state of the distortion-free object. Accordingly, the image quality can be improved, thereby increasing the yield of the high-quality images.

Additionally, since the segmentation result for the target image is used to describe the positions of the respective parts of the object in the target image, the segmentation result can represent the distribution presented by the respective parts of the object with the distortion in the object state described by the target image, and the difference presented between the segmentation result and the three-dimensional model corresponding to the target image in the part distribution can accurately represent the distortion in the object within the target image (e.g., an extra arm or a missing hand). Accordingly, the abnormal region determined based on the segmentation result and the three-dimensional model can represent the distortion in the target image, such that the restoration result determined based on the abnormal region can overcome the distortion. Accordingly, the image quality can be improved, thereby increasing the yield of the high-quality images.

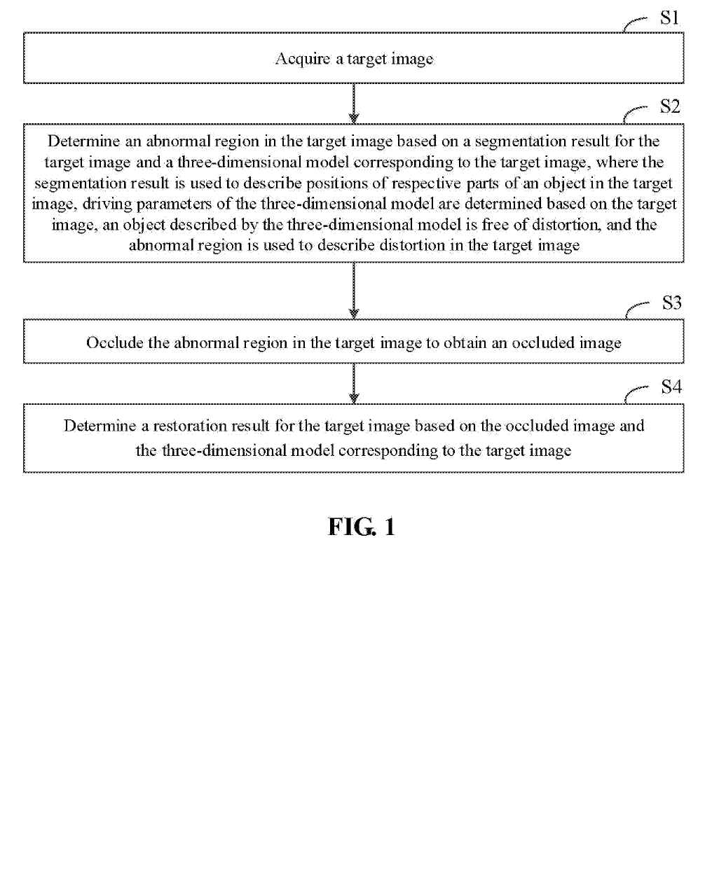

For a better understanding of the technical solutions provided in this application, an image restoration method provided in this application is first described in combination with some accompanying drawings. As shown in FIG. 1, an image restoration method provided in an embodiment of this application includes the following steps S1 to S4. FIG. 1 is a flowchart of an image restoration method according to an embodiment of this application.

S1: A target image is acquired.

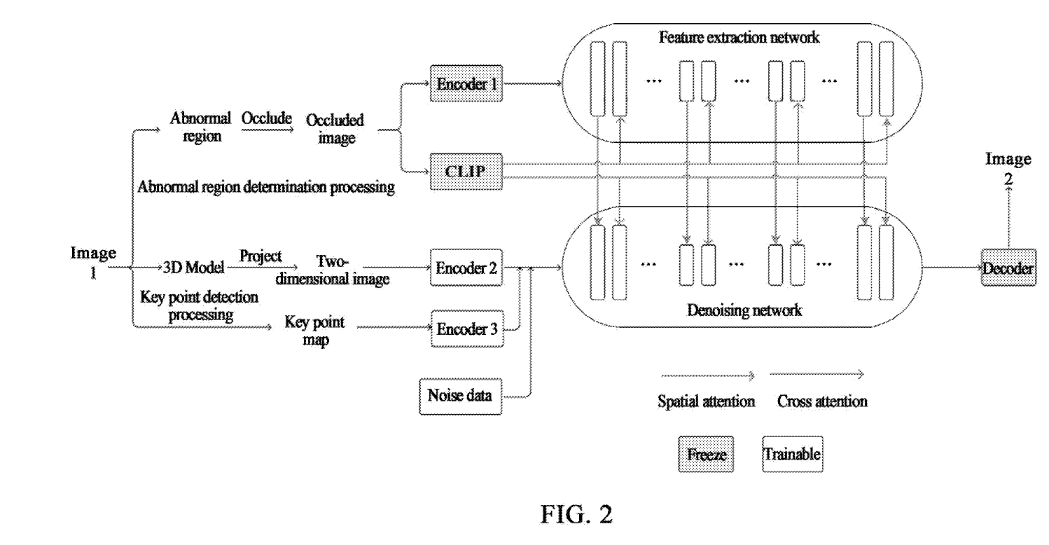

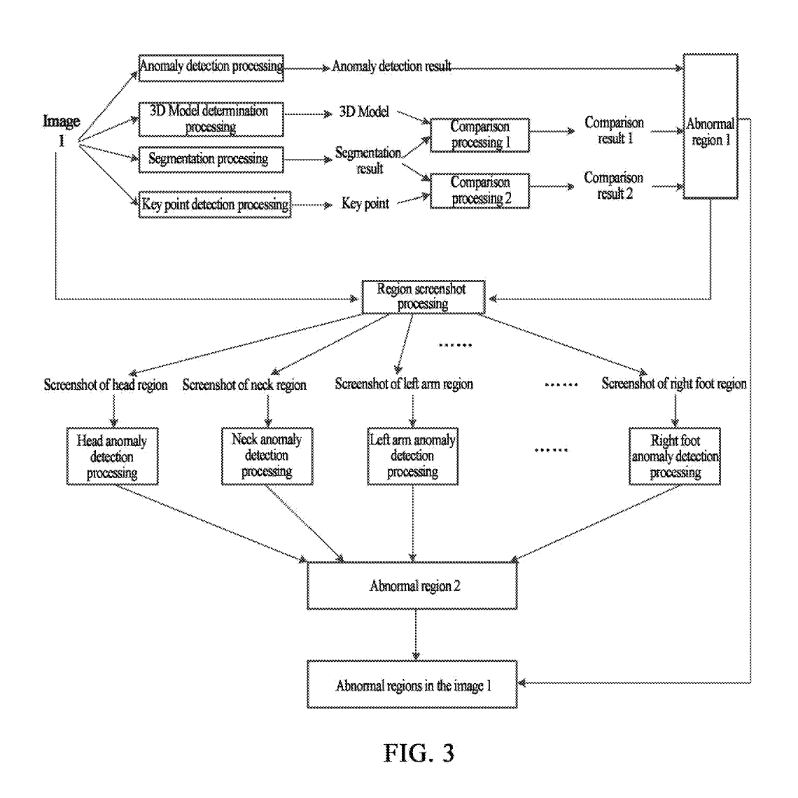

The target image refers to an image that requires restoration processing, such as an image 1 shown in FIG. 2 or FIG. 3.

Additionally, this application does not limit the target image. For example, the target image may be a newly generated image produced by AI-based image generation technology that contains distortion (e.g., extra limbs and missing limbs).

Apparently, in a possible implementation, the target image may at least meet the following constraints: an object in the target image exhibits at least one type of distortion, such as at least one limb abnormality, resulting in that the target image is of relatively poor quality and thus requires restoration processing to enhance the image quality. It should be noted that an implementation of the object is not limited in this application. For example, the object may be implemented through a human, an animal, a virtual image, or a digital human.

S2: An abnormal region in the target image is determined based on a segmentation result for the target image and a three-dimensional model corresponding to the target image, where the segmentation result is used to describe positions of respective parts of the object in the target image, driving parameters of the three-dimensional model are determined based on the target image, an object described by the three-dimensional model is free of distortion, and the abnormal region is used to describe distortion in the target image.

The segmentation result for the target image is obtained after performing segmentation processing on the target image, such that the segmentation result is used to describe the positions of the respective parts of the object in the target image, so as to enable the segmentation result to indicate regions where the different parts are located in the target image so as to represent the distribution of the respective parts of the object in the target image.

It should be noted that this application does not limit an implementation of the segmentation processing involved in the preceding paragraph. For example, any method capable of implementing image segmentation processing may be used, such as using a machine learning model with an image segmentation function. Additionally, this application does not limit an implementation of the machine learning model.

The three-dimensional model corresponding to the target image is used to display some states, such as a body shape and a pose of the object in the target image within a three-dimensional (3D) space. It should be noted that this application does not limit an implementation of the three-dimensional model, which may be, for example, implemented using a parameterized model such as a skinned multi-person linear model (SMPL).

Additionally, this application does not limit a method for determining the three-dimensional model corresponding to the target image, which may, for example, specifically include the following steps 11 to 12.

Step 11: A target parameter is determined based on the target image, such that a state (e.g., the body shape and the pose) described by the target parameter is as close as possible to a state of the object in the target image, thereby ensuring that the state presented by the three-dimensional model driven by the target parameter is as close as possible to the state of the object in the target image.

The target parameter refers to a model driving parameter determined based on the target parameter, such as a body shape parameter and a pose parameter.

Additionally, this application does not limit an implementation of the target parameter. For example, the target parameter may include the body shape parameter and the pose parameter. The body shape parameter is used to describe the body shape of the object in the target image. The pose parameter is used to describe the pose of the object in the target image.

Additionally, this application does not limit an implementation of step 11 above, which may be, for example, implemented using any existing or future method capable of extracting skinned multi-person linear model (SMPL) parameters from an image, such as using a machine learning model with an SMPL parameter extraction function. It should be noted that this application does not limit an implementation of the machine learning model.

For another example, step 11 above may specifically include: performing a driving parameter search process based on the target image to obtain the target parameter, such that the state (e.g., the body shape and the pose) described by the target parameter is as close as possible to the state of the object in the target image, thereby ensuring that the state presented by the three-dimensional model driven by the target parameter maximizes similarity to the state of the object in the target image.

Step 12: A pre-constructed standard three-dimensional model is driven using the target parameter to obtain a three-dimensional model corresponding to the target image, such that a state presented by the three-dimensional model aligns with the state of the object in the target image.

The standard model refers to a pre-constructed distortion-free three-dimensional model used to describe a state of an object in the 3D space, such as an SMPL model, thereby allowing the standard model to represent the state, such as the body shape and the pose of a distortion-free object in the 3D space, and then facilitating the standard model to accurately display states of the distortion-free object under different conditions (e.g., varying degrees of obesity and different poses) when driven by different parameters.

Additionally, this application does not limit an implementation of driving involved in step 12 above, which may be, for example, implemented using any or future method capable of adjusting a state of the parameterized model based on parameters.

Additionally, this application does not limit the specific meaning of "aligns with" involved in step 12 above. For example, it may be used to indicate a high degree of similarity. Apparently, the actual meaning of the content "information 1 aligns with information 2" is that the similarity between the information 1 and the information 2 is higher than a preset similarity threshold, such that the content can represent a high degree of similarity between the information 1 and the information 2.

Based on the relevant content of steps 11 to 12 above, it may be inferred that for some scenarios, such as a scenario where an object state is described using the SMPL parameters, after acquiring the target image (e.g., the image 1 shown in FIG. 2 or FIG. 3), the target image may be first input into a pre-constructed SMPL parameter extraction model, thereby allowing the SMPL parameter extraction model to perform SMPL parameter extraction processing on the target image to obtain a target parameter, such that a state described by the target parameter aligns with the state of the object in the target image. Subsequently, the target parameter is used to drive the pre-constructed standard model, to obtain the three-dimensional model corresponding to the target image (e.g., the 3D model shown in FIG. 2 or FIG. 3), such that the state presented by the three-dimensional model aligns with the state of the object in the target image. Since the standard model is used to describe a distortion-free object, the three-dimensional model obtained by driving the standard model can describe the distribution of respective parts of the distortion-free object in the state described by the target parameter, thereby allowing the three-dimensional model to represent the distribution of the respective parts of the distortion-free object in the object state described by the target image, and facilitating the subsequent use of the three-dimensional model as a reference to determine distortion in the target image, such as abnormal limb counts.

The abnormal region in the target image is used to describe distortion in the target image, such as extra limbs or missing limbs, such that the abnormal region can represent locations of the distortion in the target image, to facilitate the subsequent restoration processing on the abnormal region.

Additionally, this application does not limit a method for determining the abnormal region mentioned above. For example, the method may specifically include: first, inputting the segmentation result for the target image and the three-dimensional model corresponding to the target image into a pre-constructed difference identification model to obtain a difference identification result output by the difference identification model, such that the difference identification result can indicate a difference between a part described by the three-dimensional model and a part described by the segmentation result, such as the presence of extra parts or the absence of certain parts; and then, determining, based on the difference identification result, the abnormal region in the target image, such that the abnormal region can indicate a part of the object in the target image that is deformed compared to the object described by the three-dimensional model.

For another example, to better improve accuracy, this application further provides a method for determining the abnormal region mentioned above, which may specifically include the following steps 21 to 23.

Step 21: The three-dimensional model corresponding to the target image is projected to an image space of the target image to obtain a two-dimensional image, where the two-dimensional image is used to describe a state of the object described by the three-dimensional model in a two-dimensional (2D) space, to enable the two-dimensional image to represent the distribution, in the 2D space, of the respective parts of the distortion-free object in the object state described by the target image.

The two-dimensional image is obtained by projecting the three-dimensional model corresponding to the target image to the image space of the target image, such that a position occupied by a object in the two-dimensional image and a position occupied by the object in the target image are kept as consistent as possible, thereby ensuring that positions of respective parts in the two-dimensional image are as close as possible to the positions of the corresponding parts in the target image, and allowing the two-dimensional image to better serve as a reference for determining distortion in the target image, such as abnormal limb counts.

Additionally, this application does not limit an implementation of step 21 above. For example, it may be implemented using any existing or future method that can project a three-dimensional model to a two-dimensional image space.

Step 22: A segmentation result for the two-dimensional image is compared with the segmentation result for the target image to obtain a comparison result, where the comparison result is used to describe a difference between the object in the two-dimensional image and the object in the target image, such as the presence of extra parts or the absence of certain parts, thereby allowing the comparison result to represent a difference in the part distribution between the two-dimensional image and the target image and then to represent discrepancies in the parts of the target image compared to the parts in the two-dimensional image, and then causing the comparison result to indicate the distortion present in the target image.

The segmentation result for the two-dimensional image is obtained after performing segmentation processing on the two-dimensional image, such that the segmentation result is used to describe the positions of the respective parts of the object in the two-dimensional image, thereby allowing the segmentation result to indicate regions where the different parts are located in the two-dimensional image so as to represent the distribution of the respective parts of the object in the two-dimensional image, and then causing the segmentation result to represent the state of the respective parts of the distortion-free object in the 2D space as described by the three-dimensional model corresponding to the target image mentioned above.

Step 23: The abnormal region in the target image is determined based on the comparison result mentioned above, such that the abnormal region can indicate deformed parts of the object in the target image compared to the object described by the three-dimensional model corresponding to the target image.

Based on the relevant content of steps 21 to 23 above, it may be inferred that for some scenarios, such as a scenario focusing on repairing abnormalities related to limb counts, after acquiring the three-dimensional model corresponding to the target image, the two-dimensional image is first determined from the three-dimensional model, thereby allowing the state of the object in the two-dimensional image to be as close as possible to the state of the object in the target image, and causing the two-dimensional image to describe characteristics, such as a body structure of the object described by the three-dimensional model within the two-dimensional image space. Then, the segmentation result for the two-dimensional image is compared with the segmentation result for the target image to obtain the comparison result, thereby allowing the comparison result to describe the differences between the part described by the two-dimensional image and the part described by the target image. Subsequently, based on the comparison result, the abnormal region in the target image is determined, thereby allowing the abnormal region to indicate the distortion in the target image.

Additionally, to better improve accuracy, this application further provides a method for determining the abnormal region, which may specifically include the following steps 31 to 33.

Step 31: The first abnormal information is determined based on the segmentation result for the target image and the three-dimensional model of the target image, where the first abnormal information is used to describe the differences between the part described by the three-dimensional model and the part described by the segmentation result.

The first abnormal information is determined through a comparison result (e.g., a comparison result 1 shown in FIG. 3) between the segmentation result for the target image and the three-dimensional model of the target image, thereby allowing the first abnormal information to describe the differences between the part described by the three-dimensional model and the part described by the segmentation result, such as the presence of extra parts or the absence of certain parts. Accordingly, the first abnormal information can represent discrepancies in the parts of the target image compared to the parts in the three-dimensional image, and then can indicate distortion determined when the three-dimensional model is used as the reference.

Additionally, this application does not limit an implementation of step 31 above. For example, step 31 may be implemented using a data processing process shown in steps 21 to 23 above.

Step 32: The second abnormal information is determined based on the segmentation result for the target image and a key point detection result for the target image, where the second abnormal information is used to describe differences between part described by the key point detection result and the part described by the segmentation result.

The key point detection result for the target image is obtained after performing key point detection processing on the target image, thereby allowing the key point detection result to represent locations of various key points of the object in the target image, and then causing the key point detection result to represent a body structure of the object in the target image, such as a skeletal framework. Accordingly, the key point detection result can represent the distribution of the respective parts of the object in the target image, and then can accurately indicate a pose of the object in the target image.

Additionally, this application does not limit an implementation of the key point detection processing involved in the preceding paragraph, which may be, for example, implemented using any existing or future method that can detect a key point from one image, such as a pre-constructed machine learning model with a key point detection function. It should be noted that this application does not limit an implementation of the machine learning model.

Additionally, this application does not limit a representation method of the key point detection result for the target image mentioned above. For example, it may be implemented using any key point representation method, such as coordinates or images. Apparently, in some scenarios, the key point detection result may be represented using an image method, such as a key point map as shown in FIG. 2, thereby allowing the key point detection result to more vividly and accurately describe the distribution of a key point of one object in the image space.

Additionally, to better improve accuracy, this application further provides a method for determining the key point detection result for the target image, which may specifically include: performing key point detection processing on the target image using a pre-constructed key point detector to obtain the key point detection result for the target image, thereby ensuring that an object described by the key point detection result is as distortion-free as possible, and then granting the key point detection result a higher reference value. The key point detector is used to perform key point detection processing on input data of the key point detector. Further, this application does not limit an implementation of the key point detector.

Further, to ensure that the key point detector has certain distortion exclusion performance, this application further provides an implementation of the key point detector. In this implementation, the key point detector may at least meet the following constraints: the key point detector is trained using a second image and key point label information of the second image, an object in the second image is distortion-free, and the key point label information describes an actual position of a key point of the object in the second image. The second image refers to an image used during the training of the key point detector to describe a distortion-free object. The key point label information refers to information used during the training of the key point detector to describe the actual position of the key point of the object in the second image, thereby subsequently regarding the key point label information as a ground truth of the key point to guide the training process of the key point detector.

Apparently, for the key point detector mentioned in the preceding paragraph, since training data of the key point detector is used to describe the distortion-free object, when the training data is used to train the key point detector, the key point detector can fully learn how to perform the key point detection processing on the distortion-free object. Accordingly, the finally trained key point detector can learn a distribution rule of the key point of the distortion-free object, thereby allowing the key point detector to accurately grasp key point distribution characteristics presented by the distortion-free object under various conditions (e.g., various body shapes and poses). Therefore, when the key point detector is used to perform the key point detection processing on an image containing distortion, the key point detector can, to the greatest extent possible, provide a key point of the distortion-free object in a pose described by the "image containing distortion", thereby ensuring that the object described by the key point detection result output by the key point detector is as distortion-free as possible, such as free from abnormalities like extra or missing limbs. Subsequently, the key point detection result can serve as another reference to determine distortion in the corresponding image, such as abnormal limb counts.

Based on the relevant content of the key point detection result mentioned above, it may be inferred that the key point detection result for the target image above may at least meet the following constraint: the object described by the key point detection result is distortion-free, thereby allowing the key point detection result to serve as another reference to determine the distortion in the target image, such as the abnormal limb counts.

The second abnormal information is determined through a comparison result (e.g., a comparison result 2 shown in FIG. 3) between the segmentation result for the target image and the key point detection result for the target image, thereby allowing the second abnormal information to describe the differences between the part described by the key point detection result and the part described by the segmentation result, such as the presence of extra parts or the absence of certain parts. Accordingly, the second abnormal information can represent discrepancies in the parts of the target image compared to the parts described by the key point detection result, and then can indicate the distortion determined when the key point detection result is used as the reference.

Additionally, this application does not limit an implementation of step 32 above. For example, when the key point detection result for the target image is used to describe positions of a plurality of key points and the segmentation result for the target image is used to describe positions of a plurality of regions, step 32 may specifically include: first, performing attribution determination processing on the positions of these key points and the positions of these regions to obtain a position attribution result, thereby allowing the position attribution result to indicate which region each key point falls into, and to provide a clear representation of how many key points are present within each region. Subsequently, based on the position attribution result, the second abnormal information is determined, thereby allowing the second abnormal information to indicate which regions exhibit abnormalities, such as having zero key points or some key points falling into positions outside the plurality of regions. Accordingly, the second abnormal information can describe the differences between the part described by the key point detection result and the part described by the segmentation result.

Additionally, this application does not limit a relationship between an execution time of step 32 above and an execution time of step 31 above. For example, the former is earlier than the latter. For another example, the former is later than the latter. Alternatively, both are the same.

Step 33: The abnormal region in the target image is determined based on the first abnormal information and the second abnormal information.

It should be noted that this application does not limit an implementation of step 33 above. For example, it may specifically include: integrating an abnormal region described by the first abnormal information with an abnormal region described by the second abnormal information to obtain the abnormal region in the target image, thereby ensuring that the abnormal region in the target image not only include an abnormal region determined by using the three-dimensional model corresponding to the target image as the reference but also include an abnormal region determined by using the key point detection result for the target image as the reference, and making the abnormal region in the target image more comprehensive.

It should also be noted that this application does not limit an implementation of the integration mentioned in the preceding paragraph. For example, it may include first summarizing the abnormal region described by the different information and then performing deduplication on summarized results to obtain the abnormal region in the target image.

Based on the relevant content of steps 31 to 33 above, it may be inferred that for some scenarios, after acquiring the segmentation result for the target image, a plurality of references may be utilized to respectively determine whether each part described by the segmentation result exhibits distortion, thereby obtaining the abnormal region in the target image. Accordingly, the abnormal region can more comprehensively describe the distortion present in the target image, which is conducive to improving a distortion detection effect, and then better improving the image quality.

Additionally, to better improve accuracy, this application further provides a method for determining the abnormal region, which may specifically include the following steps 41 to 42.

Step 41: The first abnormal information is determined based on the segmentation result for the target image and the three-dimensional model of the target image, where the first abnormal information is used to describe the differences between the part described by the three-dimensional model and the part described by the segmentation result.

It should be noted that for the relevant content of step 41, reference is made to the relevant content of step 31 above, and for brevity, is not repeated herein.

Step 42: The abnormal region in the target image is determined based on the first abnormal information and an anomaly detection result for the target image.

The anomaly detection result for the target image is obtained after directly performing anomaly detection processing on the target image, thereby allowing the anomaly detection result to represent which distortions are present in the object of the target image.

Additionally, the anomaly detection result for the target image is obtained by processing the target image using an anomaly detector. The anomaly detector is used to perform abnormal (distortion) detection processing on input data of the anomaly detector. Further, this application does not limit an implementation of the anomaly detector. For example, the anomaly detector may be implemented using a convolutional neural network, such as a yolov8 architecture.

Moreover, to better improve accuracy, the above-mentioned anomaly detector may be trained using a positive sample image, a negative sample image, and anomaly label information of the negative sample image. An object in the positive sample image is distortion-free, while an object in the negative sample image exhibits distortion. The anomaly label information is used to describe an actual position of distortion in the negative sample image.

For the positive sample image above, the positive sample image refers to an image used during the training of the anomaly detector to describe the distortion-free object, thereby allowing the anomaly detector to learn characteristics of the distortion-free image from the positive sample image, and causing the anomaly detector to have better performance. Additionally, since the positive sample image is free of distortion, anomaly label information of the positive sample image may be set as preset information, such as information used to describe the absence of a detection box, thereby allowing the anomaly label information to indicate that there are no distortion in the positive sample image. Subsequently, the anomaly label information may be used as a ground truth to guide the training process of the anomaly detector.

For the negative sample image above, the negative sample image refers to an image used during training of the abnormal detector, which are used to describe objects exhibiting one or more distortions, thereby allowing the anomaly detector to learn characteristics of the image containing these distortion from the negative sample image, and causing the anomaly detector to have better performance. Additionally, the anomaly label information of the negative sample image refers to information that is pre-annotated for the negative sample image to describe the actual position of the distortion in the negative sample image. Subsequently, the anomaly label information may be used as a ground truth to guide the training process of the anomaly detector.

Based on the relevant content of the anomaly detector above, it may be inferred that for the anomaly detector, training data of the anomaly detector includes a tuple (the positive sample image and the anomaly label information of the positive sample image) and a tuple (the negative sample image and the anomaly label information of the negative sample image), thereby allowing the training data of the anomaly detector to describe various images as much as possible, such as a large number of distortion-free images and a large number of deformed images. Accordingly, the training data of the anomaly detector may be used to describe a wide variety of distortion issues, thereby allowing the anomaly detector trained based on the training data to detect as many diverse distortions as possible. Therefore, the anomaly detection result output by the anomaly detector can represent as many diverse distortions as possible, such as abnormal finger shapes, thereby enhancing a distortion detection result.

Apparently, for the anomaly detection result for the target image above, since the anomaly detection result is obtained by processing the target image using the trained anomaly detector, the anomaly detection result can indicate certain distortions present in the target image, such as abnormal hand contours, thereby ensuring that the abnormal region determined based on the anomaly detection result are more comprehensive.

Additionally, this application does not limit an implementation of step 42 above. For example, it may specifically include: integrating the abnormal region described by the first abnormal information with an abnormal region described by the anomaly detection result above to obtain the abnormal region in the target image, thereby ensuring that the abnormal region in the target image not only include the abnormal region determined by using the three-dimensional model corresponding to the target image as the reference but also include an abnormal region determined by using the anomaly detector, and making the abnormal region in the target image more comprehensive.

For another example, to better improve accuracy, step 42 above may specifically include: determining the abnormal region in the target image based on the first abnormal information, the second abnormal information, and the anomaly detection result for the target image.

It should be noted that this application does not limit an implementation of step 42 in the preceding paragraph. For example, it may specifically include: integrating the abnormal region described by the first abnormal information, the abnormal region described by the second abnormal information, and the abnormal region described by the anomaly detection result above to obtain the abnormal region in the target image, thereby ensuring that the abnormal region in the target image include the abnormal region determined by using the three-dimensional model corresponding to the target image as the reference, the abnormal region determined by using the key point detection result for the target image as the reference, and the abnormal region determined by using the anomaly detector, and making the abnormal region in the target image more comprehensive.

Based on the relevant content of steps 41 to 42 above, it may be inferred that for some scenarios, after acquiring the target image, a plurality of abnormality determination methods, such as various abnormality determination methods shown in FIG. 3 may be used to position the abnormal region in the target image, thereby allowing the abnormal region to more comprehensively describe the distortion present in the target image, which is conducive to improving the distortion detection effect, and then better improving the image quality.

Researches reveal that for some distortion, such as missing fingernails, a pixel proportion of the distortion in the image is low, making the detection of the distortion more challenging, resulting in a poor distortion detection effect.

Based on the above-mentioned researches, to better improve the distortion detection result, this application further provides a method for determining the abnormal region above, which may at least include the following steps 51 to 54.

Step 51: The abnormal region in the target image is determined based on the segmentation result for the target image and the three-dimensional model corresponding to the target image.

It should be noted that this application does not limit an implementation of step 51. For example, step 51 may be implemented using the data processing process described in steps 21 to 23 above, a data processing process described in steps 31 to 33, or a data processing process described in steps 41 to 42.

Apparently, in a possible implementation, step 51 above may specifically include: determining an abnormal region in the target image (e.g., an abnormal region 1 in FIG. 3) based on the segmentation result for the target image, the three-dimensional model corresponding to the target image, the key point detection result for the target image, and the anomaly detection result for the target image, thereby allowing the abnormal region to comprehensively describe, to the greatest extent possible, some distortions present in the target image, such as distortion with a large pixel proportion.

Step 52: A screenshot of at least one region is determined from the target image, where different regions are used to describe different parts of the object in the target image, and the at least one region does not include the abnormal region in the target image.

Regarding the "at least one region" in the preceding paragraph, the at least one region refers to other regions present in the target image, excluding the determined abnormal region, such as regions without distortion or regions containing distortion with a small pixel proportion, thereby subsequently using detail magnification means to continuously determine whether distortion is present in the at least one region.

Additionally, for the "at least one region" mentioned above, the "at least one region" at least meets the following constraint: different regions are used to describe different parts of the object in the target image. Apparently, in a possible implementation, the "at least one region" may include a head region, a neck region, a left arm region, a right foot region, etc., as shown in FIG. 3.

Additionally, for any region in the "at least one region" above, a screenshot of the region refers to an image that is extracted from the target image, and is specially used to describe the region. Therefore, the region occupies a large pixel proportion within the screenshot (e.g., exceeding a preset pixel ratio threshold), thereby allowing the screenshot to better describe detailed information of the region. It should be noted that this application does not limit a method for acquiring the screenshot, which may be, for example, implemented using any existing or future screenshot method. For another example, to better improve the distortion detection effect, the screenshot may be obtained through a local magnification method, thereby allowing the screenshot to more accurately describe the detailed information of the region, and to more clearly indicate whether the region exhibits distortion.

Based on the relevant content of step 52 above, it may be inferred that for the target image, after determining some abnormal regions from the target image using some methods, screenshot processing may be performed on the remaining regions of the target image excluding these abnormal regions to obtain the screenshot of the at least one region, such as the screenshot shown in FIG. 3, thereby allowing the screenshots of the different regions to better describe detailed information of the corresponding regions, and facilitating subsequent distortion detection processing using these screenshots.

Step 63: For any region within the previously described at least one region, an anomaly detection processing is performed on a screenshot of the region to obtain an anomaly detection result for the region, thereby allowing the anomaly detection result to indicate whether distortion is present in the region.

It should be noted that this application does not limit an implementation of the anomaly detection processing involved in step 63 above. For example, to better improve the distortion detection result, step 63 may specifically include: for any region within the above-mentioned at least one region, using the anomaly detector pre-constructed for a part described by the region to perform the anomaly detection processing on the screenshot of the region, to obtain the anomaly detection result for the region, thereby allowing the anomaly detection result to indicate whether there is distortion in the part described by the region. The anomaly detector is used to detect whether there is distortion in the part described by the region. Moreover, this application does not limit an implementation of the anomaly detector.

Step 64: Based on the anomaly detection result for each region within the above-mentioned at least one region, update the abnormal region in the target image, thereby ensuring that the updated abnormal region not only represent distortion with a large pixel proportion (e.g., distortion described by the abnormal region 1 in FIG. 3) but also represent distortion with a small pixel proportion (e.g., distortion described by the abnormal region 2 in FIG. 3), and then causing the abnormal region to more comprehensively describe the distortion present in the target image, improving the distortion detection effect and, in turn, better improving the image quality.

Based on the relevant content of steps 61 to 64 above, it may be inferred that for some scenarios, after acquiring the target image, some methods may be first used to determine the abnormal region within the target image that include the distortion with the large pixel proportion; then, local magnification processing is performed on other regions within the target image except the abnormal region, to obtain a local magnification result for each region; then, the anomaly detection processing is performed on the local magnification result for each region to obtain the abnormal region within the target image that include the distortion with the small pixel proportion; and finally, these abnormal regions including the distortion with the large pixel proportion and these abnormal regions including the distortion with the small pixel proportion are summarized to obtain the abnormal region within the target image, thereby allowing the abnormal region to more comprehensively describe the distortion present in the target image, improving the distortion detection effect and, in turn, better improving the image quality.

Based on the relevant content of S2 above, it may be inferred that for some scenarios, after acquiring the target image, abnormal region determination processing is performed on the target image, such as the abnormal region determination processing shown in FIG. 2 or FIG. 3, to obtain the abnormal region in the target image, thereby allowing the abnormal region to describe the positions of the distortion within the target image, and facilitating subsequent image quality enhancement through the repair of the abnormal region.

S3: The abnormal region within the target image is occluded to obtain an occluded image.

The occluded image refers to a result obtained by occluding the abnormal region within the target image, such that these abnormal regions no longer exist in the occluded image. Therefore, the occluded image contains as little distortion as possible, thereby allowing the occluded image to provide other content except these distortion for the image restoration process, such as some characteristics of the object in the target image (e.g., a facial identifier and a clothing identifier), a background of the target image, and a style of the target image. Accordingly, an image restoration result obtained based on the occluded image can retain the other content as much as possible. It should be noted that this application does not limit the specific meaning of "retain" involved in the preceding paragraph. For example, it may refer to identical or highly similarity.

S4: A restoration result for the target image is determined based on the occluded image and the three-dimensional model corresponding to the target image.

The restoration result for the target image refers to a result obtained by repairing the abnormal region within the target image, such that the distortion described by the abnormal region no longer exist in the restoration result. Therefore, the restoration result contains no or as little distortion as possible.

Additionally, this application does not limit an implementation of S4 above. For example, it may be implemented using a pre-constructed machine learning model with an image restoration function, similar to a dual UNet network shown in FIG. 2.

Apparently, in a possible implementation, S4 above may be implemented using a pre-constructed image restoration model, thereby allowing the image restoration model to determine the restoration result for the target image based on the occluded image and the three-dimensional model corresponding to the target image, causing the restoration result to retain as much of the content described by the occluded image as possible, and ensuring that a state (e.g., the body shape and the pose) described by the restoration result aligns as closely as possible with the state described by the three-dimensional model. The image restoration model is used to provide the image restoration function. Moreover, this application does not limit an implementation of the image restoration model. For example, the image restoration model may be implemented using an image generation method, such as an image generation method implemented using a diffusion model.

The researches reveal that the driving parameters of the three-dimensional model corresponding to the target image are predicted based on the target image, such that the pose described by the driving parameters closely approximates, but is not identical to, the pose described by the target image. Accordingly, a certain difference exists between the pose described by the three-dimensional model and the pose described by the target image, making it difficult for the three-dimensional model to accurately represent an actual pose of the object in the target image. As a result, the pose of the object in the image restored based on the three-dimensional model may have some slight changes relative to the pose described by the target image, thereby affecting the image restoration effect.

The researches also reveal that the key point detection result for the target image can accurately describe the pose of the object within the target image. Therefore, to better improve the image restoration effect, this application further provides a possible implementation of S4 above. In this implementation, S4 may specifically include: determining the restoration result for the target image based on the occluded image, the three-dimensional model corresponding to the target image, and the key point detection result for the target image, thereby allowing the restoration result to retain as much of the content described by the occluded image as possible, aligning the pose described by the restoration result with the pose described by the key point detection result, and aligning other states (e.g., the body shape and the body structure) described by the restoration result except the pose, as closely as possible with the corresponding state described by the three-dimensional model.

Additionally, this application does not limit a method for determining the restoration result shown in the preceding paragraph. For example, it may be implemented using the pre-constructed machine learning model with the image restoration function.

Further, to better improve the image restoration effect, this application further provides a possible implementation of S4 above. In this implementation, S4 may specifically include the following steps 71 to 72.

Step 71: The three-dimensional model corresponding to the target image is projected to the image space of the target image to obtain a two-dimensional image.

It should be noted that for the relevant content of step 71, reference is made to the relevant content of step 21 above, and for brevity, is not repeated herein.

Step 72: A restoration result for the target image is projected based on the occluded image, the two-dimensional image, and the key point detection result for the target image.

It should be noted that this application does not limit an implementation of step 72 above. For example, it may be implemented using the pre-constructed machine learning model with the image restoration function. Apparently, in a possible implementation, step 72 may specifically include: processing the occluded image, the two-dimensional image, and the key point detection result for the target image using the image restoration model, to obtain the restoration result for the target image.

Additionally, to better improve the image restoration effect, this application further provides a possible implementation of the image restoration model above. In this implementation, the image restoration model may at least meet at least one of the following constraints: the image restoration model includes a first encoding module, a second encoding module, a first network, a second network, and a decoder; a network structure of the first encoding module is identical to that of the second encoding module; and a network structure of the first network is identical to that of the second network.

Regarding the above-mentioned first encoding module, as illustrated by an encoder 3 in FIG. 2, the first encoding module refers to a module within the image restoration model that is used to extract pose features from key point information, thereby allowing output data of the first encoding module to better represent a pose described by the key point information.

Apparently, in a possible implementation, the above-mentioned first encoding module may be used to perform feature extraction processing on the key point detection result for the target image (e.g., the key point map shown in FIG. 2) to obtain a feature extraction result for the key point detection result, thereby allowing the feature extraction result to represent first information carried by the key point detection result, such as the pose. The first information refers to information carried by the key point detection result. This application does not limit the first information. For example, the first information may at least include the pose.

Additionally, this application does not limit an implementation of the above-mentioned first encoding module. For example, the first encoding module may be implemented using the convolutional neural network.

Regarding the above-mentioned second encoding module, as illustrated by an encoder 2 in FIG. 2, the second encoding module refers to a module within the image restoration model that is used to extract state features from the two-dimensional image above, thereby allowing output data of the second encoding module to better represent a state described by the two-dimensional image.

Apparently, in a possible implementation, the above-mentioned second encoding module may be used to perform feature extraction processing for the above-mentioned two-dimensional image (e.g., the two-dimensional image shown in FIG. 2) to obtain a feature extraction result for the two-dimensional image, thereby allowing the feature extraction result to represent second information carried by the two-dimensional image, such as the pose and the body shape. The second information refers to information carried by the two-dimensional image. This application does not limit the second information. For example, the second information may at least include the body shape and the body structure.

It should be noted that for the information carried by the two-dimensional image and the information carried by the key point detection result, the pose information carried by the key point detection result can more accurately describe the pose of the object in the target image, whereas the pose information carried by the two-dimensional image only approximates the pose of the object in the target image. Accordingly, a reference value of the pose carried by the key point detection result is higher than a reference value of the pose carried by the two-dimensional image. Therefore, in the image restoration process, emphasis is placed on pose generation processing based on the pose carried by the key point detection result, which can effectively ensure pose retaining in the image restoration process. Additionally, since the body structure information carried by the two-dimensional image is free of distortion, whereas the body structure information carried by the key point detection result may contain distortion, a reference value of the body structure carried by the two-dimensional image is higher than a reference value of the body structure carried by the two-dimensional image. Therefore, in the image restoration process, emphasis is placed on body structure generation processing based on the body structure carried by the two-dimensional image, thereby effectively ensuring distortion removal in the image restoration process. Apparently, the information carried by the two-dimensional image and the information carried by the key point detection result can comprehensively describe an effect presented by the distortion-free object in the object state described by the target image, resulting in a better image restoration effect based on the two types of information.

Additionally, this application does not limit an implementation of the above-mentioned second encoding module. For example, the second encoding module may at least meet the following constraints: a network structure of the second encoding module is identical to the network structure of the above-mentioned first encoding module, but parameters within the second encoding module differ from parameters within the first encoding module to ensure that the two modules respectively achieve different functions. Apparently, in a possible implementation, the second encoding module may be implemented using the convolutional neural network.

Regarding the above-mentioned first network, as illustrated by a feature extraction network in FIG. 2, the first network refers to a network within the image restoration model that is used to acquire image features of the occluded image. Meanwhile, the first network is specifically used to determine the image features of the occluded image based on an image encoding result and a semantic feature extraction result for the occluded image, thereby allowing the image features to better describe information carried by the occluded image, such as detailed information about respective parts and a global framework of the entire image.

Regarding the image encoding result for the above-mentioned occluded image, the image encoding result is obtained by performing image encoding processing on the occluded image, thereby allowing the image encoding result to better represent the information carried by the occluded image, such as pixel-level information and global information. Additionally, this application does not limit a method for acquiring the image encoding result. For example, the image encoding result may be obtained by performing the image encoding processing on the occluded image using a pre-constructed image encoder. The image encoder is used to perform the image encoding processing on input data of the image encoder. This application does not limit an implementation of the image encoder. For example, it may be implemented using any model with an image encoding function, such as the encoder 1 shown in FIG. 2, or an encoder in a variational autoencoder (VAE) within a stable diffusion (SD) 1.5 model.

Regarding the semantic feature extraction result for the above-mentioned occluded image, the semantic feature extraction result is obtained by performing semantic extraction processing on the occluded image, thereby allowing the semantic feature extraction result to better represent semantic information carried by the occluded image, such as the global information. Additionally, this application does not limit a method for acquiring the semantic feature extraction result. For example, the semantic feature extraction result may be obtained by performing the semantic extraction processing on the occluded image using a pre-constructed image semantic extractor. The image semantic extractor is used to perform the semantic extraction processing on input data of the image semantic extractor. This application does not limit an implementation of the image semantic extractor. For example, it may be implemented using any extractor with an image semantic extraction function, such as an image encoder in a contrastive language-image pre-training (CLIP) model.

Additionally, this application does not limit an implementation of the above-mentioned first network. For example, the first network may be implemented using a Unet network, such as the feature extraction network shown in FIG. 2. Apparently, in a possible implementation, when the first network is implemented using the Unet network, a working principle of the first network may include: introducing the semantic feature extraction result for the occluded image into the first network through a cross attention method, thereby allowing the first network to process the image encoding result for the occluded image based on the semantic feature extraction result and obtain the image features of the occluded image. Therefore, the image features include output data of various modules within the first network, thereby facilitating the subsequent introduction of the output data of each module into corresponding modules of the second network through a spatial attention method for use.

Regarding the above-mentioned second network, as illustrated by a denoising network in FIG. 2, the second network refers to a network within the image restoration model that is used to implement denoising processing. The second network is specifically used to perform the denoising processing based on the semantic feature extraction result for the occluded image, the image features of the occluded image, the feature extraction result for the two-dimensional image, the feature extraction result for the above-mentioned key point detection result, and randomly generated noise data (e.g., noise data show in FIG. 2).

Additionally, the above-mentioned second network at least meets the following constraints: the network structure of the second network is identical to the network structure of the above-mentioned first network, but parameters within the second network differ from parameters within the first network to ensure that the two networks respectively achieve different functions. Apparently, in a possible implementation, the second network may be implemented using the Unet network.

Additionally, this application does not limit a working principle of the above-mentioned second network. For example, when the image features of the occluded image as mentioned above include the output data of the various modules in the first network, the working principle of the second network may specifically include: concatenating the feature extraction result for the two-dimensional image, the feature extraction result for the above-mentioned key point detection result, and the randomly generated noise data to obtain a concatenation result, introducing the semantic feature extraction result for the occluded image into the second network through the cross attention method, and introducing the output data of the various modules in the first network into the corresponding modules in the second network through the spatial attention method, thereby allowing the second network to process the concatenation result based on the introduced information to obtain a denoising result.

Regarding the above-mentioned decoder, as illustrated by a decoder in FIG. 2, the decoder refers to a network within the image restoration model that is used to implement decoding processing, and the decoder is specifically used to perform decoding processing on the above-mentioned denoising result, to obtain the restoration result for the target image, such as an image 2 shown in FIG. 2. Additionally, this application does not limit an implementation of the decoder. For example, the decoder may be implemented using a decoder within the VAE of the SD 1.5 model.

Based on the relevant content of the above-mentioned image restoration model, it may be inferred that in some scenarios, the image restoration model may include all the modules shown in FIG. 2, thereby allowing the image restoration model to process the target image according to a data processing flow shown in FIG. 2, to obtain the restoration result for the target image.

Apparently, in a possible implementation, step 72 above may specifically include: processing the occluded image, the two-dimensional image, and the key point detection result for the target image using the pre-constructed image restoration model, to obtain the restoration result for the target image.

Based on the relevant content of steps 71 to 72 above, it may be inferred that in some scenarios, after acquiring the three-dimensional model corresponding to the target image, the three-dimensional model may be first projected to the image space of the target image to obtain the two-dimensional image, thereby ensuring that an image space of the two-dimensional image and the image space of the target image are identical, and then allowing the two-dimensional image to better represent the state of the object in the target image without distortion. Then, the image restoration model is used to process the two-dimensional image, the other regions within the target image except the abnormal region, and the key point detection result for the target image, to obtain the restoration result for the target image, thereby allowing the restoration result to eliminate the distortion under the constraints comprehensively described by the two-dimensional image and the key point detection result to the fullest extent possible, thereby obtaining the distortion-free image, and then improving the image restoration effect.

Additionally, this application does not limit a method for training the above-mentioned image restoration model. For example, when the image restoration model is obtained by improving the diffusion model, the image restoration model may be implemented using any method for training the diffusion model.

Additionally, to better improve the image restoration effect, this application further provides a method for training the above-mentioned image restoration model. In the method, when the image restoration model at least includes the first encoding module, the second encoding module, the first network, the second network, and the decoder, the process of training the image restoration model specifically includes the following steps 81 to 84.

Step 81: A first image is required, where an object in the first image is free of distortion.

The first image refers to an image required for training the image restoration model, thereby subsequently using the first image to construct training data and a corresponding ground truth with guiding significance. Moreover, this application does not limit a method for acquiring the first image.

Step 82: A region is randomly selected from the first image for occlusion, to obtain a region occlusion result.

In this application, after acquiring the first image, a region (e.g., a limb region or a background region) may be randomly selected from the first image for occlusion, to obtain the region occlusion result. Accordingly, the region occlusion result lacks some image information compared to the first image, thereby subsequently using the image restoration model to restore the missing information. A missing portion in the region occlusion result is randomly determined, and accordingly, may be the limb region or a non-limb region (e.g., the background region). Accordingly, the model trained based on the region occlusion result not only has a function of repairing the limb region, but also has a function of repairing the non-limb region, thereby improving the model performance, such as improving the image restoration effect.

Step 83: A restoration result for the first image is determined based on the image restoration model, the above-mentioned region occlusion result, the three-dimensional model corresponding to the first image, and the key point detection result for the first image.

For the relevant content of the image restoration model, reference is made to the preceding description.

Additionally, this application does not limit a method for initializing the image restoration model. For example, the image restoration model may at least meet the following constraints: randomly initializing the parameters of the first encoding module within the image restoration model; randomly initializing the parameters of the second encoding module within the image restoration model; initializing the parameters of the first network within the image restoration model using parameters of the Unet network in the SD1.5 model; and initializing the parameters of the second network within the image restoration model using the parameters of the Unet network in the SD1.5 model.

Additionally, the above-mentioned method for determining the restoration result for the first image is analogous to the above-mentioned method for determining the restoration result for the target image. For brevity, details are not repeated herein.

Apparently, in a possible implementation, when the image restoration model may include all the modules shown in FIG. 2, step 83 may specifically include: first, projecting the three-dimensional model corresponding to the first image to the image space of the first image to obtain the two-dimensional image; and then inputting the two-dimensional image, the above-mentioned region occlusion result, the key point detection result for the first image, and a noise-adding result for the first image into the image restoration model, thereby allowing the image restoration model to perform the data processing flow shown in FIG. 2 and obtaining the restoration result for the first image. The noise-adding result is obtained by performing noise addition processing on the first image. It should be noted that this application does not limit an implementation of the noise addition processing.

Step 84: A portion of the networks within the image restoration model (e.g., a module with a trainable mark in FIG. 2) is updated based on a difference between the restoration result for the first image and the first image, where the portion of the networks include the first encoding module, the second encoding module, the first network, and the second network.

It should be noted that this implementation does not limit an implementation of step 84 above.

Additionally, to better improve a model training effect, step 84 above may specifically include: updating the portion of the networks within the image restoration model (e.g., the module with the trainable mark in FIG. 2) based on the difference between the restoration result for the first image and the first image, returning to continue to perform step 81 above and subsequent steps, and ending an iterative training process of the image restoration model when a preset stopping condition is met.

The preset stopping condition refers to a condition that needs to be met when the iterative training process of the image restoration model ends. Moreover, this application does not limit an implementation of the preset stopping condition. For example, the preset stopping condition may include: a model loss of the image restoration model being lower than a preset loss threshold. For another example, the preset stopping condition may include: a rate of change of the model loss of the image restoration model being lower than a preset rate of change threshold. Alternatively, the preset stopping condition may include: the number of updates to the image restoration model reaching a preset count threshold.

The model loss of the image restoration model is used to represent performance of the image restoration model, and is determined based on the difference between the restoration result for the first image and the first image. It should be noted that this application does not limit a calculation method for the model loss.

Based on the relevant content of steps 81 to 84 above, it may be inferred that in some scenarios, the image restoration model is first constructed based on the Unet network from some diffusion models; and then, the training data is constructed using some distortion-free images, to train the image restoration model.

Since the training data of the image restoration model is constructed based on the distortion-free images, the image restoration model can learn characteristics of distortion-free objects in the training process, thereby allowing the image restoration model to better learn how to generate the distortion-free objects in the training process, and to have a good image restoration capability. Since the training data is determined through a random occlusion method, the missing portion in the training data may be the limb region or the background region. Accordingly, the model obtained based on the training data not only has the function of repairing the limb region, but also has the function of repairing the non-limb region, thereby allowing the image restoration model to have a better image restoration capability.

Based on the relevant content of the image restoration model above, it may be inferred that in a possible implementation, S4 above may specifically include: determining the restoration result for the target image based on the trained image restoration model, the occluded image, and the three-dimensional model corresponding to the target image.

Based on the relevant content of S1 to S4 above, it may be inferred that for the image restoration method provided in this application, the target image is first acquired, such as the newly generated image through the AI image generation technology; then, the abnormal region in the target image is determined based on the segmentation result for the target image and the three-dimensional model corresponding to the target image, thereby allowing the abnormal region to describe the distortion in the target image; then, the abnormal region in the target image is occluded to obtain the occluded image, thereby ensuring that the occluded image contains no or as little distortion as possible; and finally, the restoration result for the target image is determined based on the occluded image and the three-dimensional model, thereby ensuring that the restoration result contains no or as little distortion as possible. Accordingly, the image quality can be improved, thereby increasing a yield of high-quality images.

Since the driving parameters of the three-dimensional model corresponding to the target image are determined based on the target image, thereby allowing the state (e.g., the body shape and the pose) of the object described by the three-dimensional model to be as close as possible to the state of the object in the target image, and ensuring that the three-dimensional model can represent the body shape, the pose, and other characteristics of the object in the target image as accurately as possible. Additionally, since the object described by the three-dimensional model is free of the distortion, the three-dimensional model can represent the distribution of the respective parts of the distortion-free object in the object state described by the target image, thereby implementing distortion removal based on the image restoration processing of the three-dimensional model, to obtain the restoration result for describing the state of the distortion-free object. Accordingly, the image quality can be improved, thereby increasing the yield of the high-quality images.

Additionally, since the segmentation result for the target image is used to describe the positions of the respective parts of the object in the target image, thereby allowing the segmentation result to represent the distribution presented by the respective parts of the object with the distortion in the object state described by the target image, and ensuring that the difference presented between the segmentation result and the three-dimensional model corresponding to the target image in the part distribution can accurately represent the distortion in the object within the target image (e.g., an extra arm or a missing hand). Accordingly, the abnormal region determined based on the segmentation result and the three-dimensional model can represent the distortion in the target image, thereby allowing the restoration result determined based on the abnormal region to overcome the distortion. Accordingly, the image quality can be improved, thereby increasing the yield of the high-quality images.

Additionally, this application does not limit an executing entity for the image restoration method according to this embodiment of this application. For example, the image restoration method according to this embodiment of this application may be applied to a terminal device or a server. For another example, the image restoration method according to this embodiment of this application may also be implemented with the aid of a data interaction process between the terminal device and the server. The terminal device may be a smartphone, a computer, a personal digital assistant (PDA), a tablet, etc. The server may be a stand-alone server, a cluster server, or a cloud server.

Based on the relevant content of the above-mentioned image restoration method, it may be inferred that the technical solutions provided in this application have the following advantages 1 to 3.

1. According to the technical solutions provided in this application, the regions where the distortion are located (e.g., the above-mentioned abnormal regions) need to be occluded, thereby ensuring that the distortion do not interfere with the image restoration process as much as possible, effectively avoiding the generation of deformed parts in the image restoration process, and then improving the image restoration effect.

2. According to the technical solutions provided in this application, the regions where the distortion are located are determined through a plurality of methods (e.g., a plurality of methods shown in FIG. 3), thereby ensuring that all distortion present in the image are detected as comprehensively as possible, effectively avoiding flaws caused by some undetected distortion, and then improving the image restoration effect.

3. According to the technical solutions provided in this application, a pose constraint, a body structure constraint, a body shape constraint, and other constraints that need to be met in the image restoration process are described by using at least one type of information (e.g., the key point detection result and the two-dimensional image), thereby repairing the distortion while preserving other content of an original image as much as possible, except for the distortion, and then achieving a better image restoration effect.

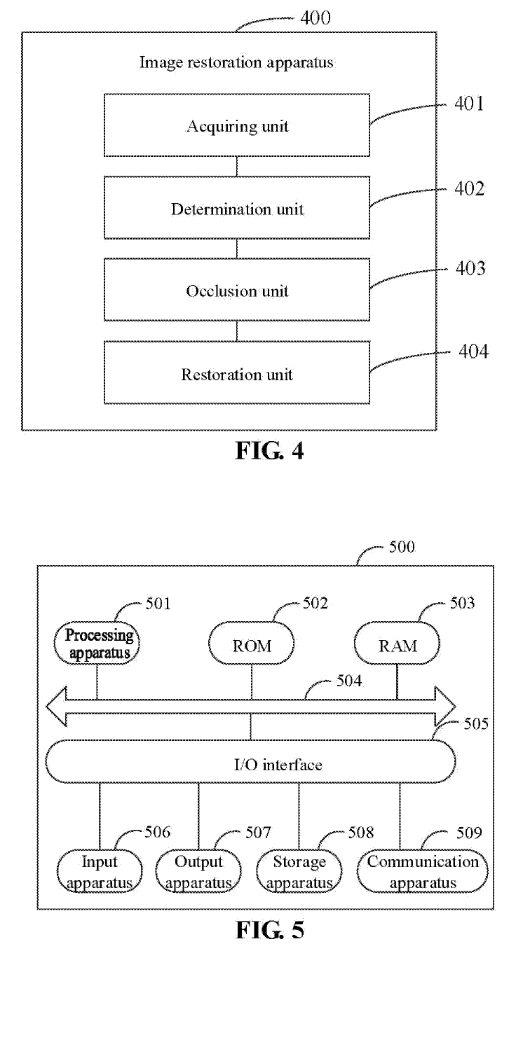

Based on the image restoration method provided in this embodiment of this application, an embodiment of this application further provides an image restoration apparatus, which is explained and illustrated in combination with FIG. 4 below. FIG. 4 is a schematic structural diagram of an image restoration apparatus according to an embodiment of this application. It should be noted that for technical details of the image restoration apparatus according to this embodiment of this application, reference is made to the relevant content of the above-mentioned image restoration method.

As shown in FIG. 4, the image restoration apparatus 400 according to this embodiment of this application includes:

an acquiring unit 401, used to acquire a target image;

a determination unit 402, used to determine an abnormal region in the target image based on a segmentation result for the target image and a three-dimensional model corresponding to the target image, where the segmentation result is used to describe positions of respective parts of an object in the target image, driving parameters of the three-dimensional model are determined based on the target image, an object described by the three-dimensional model is free of distortion, and the abnormal region is used to describe distortion in the target image;

an occlusion unit 403, used to occlude the abnormal region in the target image to obtain an occluded image; and

a restoration unit 404, used to determine a restoration result for the target image based on the occluded image and the three-dimensional model.

In a possible implementation, the determination unit 402 is specifically used to: project the three-dimensional model to an image space of the target image to obtain a two-dimensional image, where the two-dimensional image is used to describe a state of the object described by the three-dimensional model in a two-dimensional space; compare a segmentation result for the two-dimensional image with the segmentation result for the target image to obtain a comparison result, where the comparison result is used to describe a difference between an object in the two-dimensional image and the object in the target image; and determine an abnormal region in the target image based on the comparison result.

In a possible implementation, the restoration unit 404 is specifically used to: determine the restoration result for the target image based on the occluded image, the three-dimensional model, and a key point detection result for the target image, where the key point detection result is used to describe a pose of the object in the target image.

In a possible implementation, the restoration unit 404 is specifically used to: project the three-dimensional model to the image space of the target image to obtain a two-dimensional image; and determine the restoration result for the target image based on the occluded image, the two-dimensional image, and the key point detection result.

In a possible implementation, the restoration result is determined by using an image restoration model; the image restoration model includes a first encoding module, a second encoding module, a first network, a second network, and a decoder; the first encoding module is used to acquire a feature extraction result for the key point detection result, where the feature extraction result for the key point detection result is used to represent first information carried by the key point detection result, and the first information includes a pose; the second encoding module is used to acquire a feature extraction result for the two-dimensional image, where the feature extraction result for the two-dimensional image is used to represent second information carried by the two-dimensional image, and the second information includes a body shape and a body structure; the first network is used to determine image features of the occluded image based on an image encoding result and a semantic feature extraction result for the occluded image; the second network is used to perform denoising processing based on the semantic feature extraction result for the occluded image, the image features of the occluded image, the feature extraction result for the two-dimensional image, the feature extraction result for the key point detection result, and randomly generated noise data, to obtain a denoising result; and the decoder is used to decode the denoising result to obtain the restoration result for the target image.

In a possible implementation, the restoration result is determined by using an image restoration model; and a process of training the image restoration model includes: acquiring a first image, where an object in the first image is free of distortion; randomly selecting a region from the first image for occlusion, to obtain a region occlusion result; determining a restoration result for the first image based on the image restoration model, the region occlusion result, the three-dimensional model corresponding to the first image, and the key point detection result for the first image; and updating a portion of networks within the image restoration model based on a difference between the restoration result for the first image and the first image, where the portion of the networks include a first encoding module, a second encoding module, a first network, and a second network.

In a possible implementation, the determination unit 402 is specifically used to: determine first abnormal information based on the segmentation result and the three-dimensional model, and determine second abnormal information based on the segmentation result and a key point detection result for the target image, where the first abnormal information is used to describe differences between a part described by the three-dimensional model and a part described by the segmentation result, and the second abnormal information is used to describe differences between a part described by the key point detection result and the part described by the segmentation result; and determine the abnormal region in the target image based on the first abnormal information and the second abnormal information.

In a possible implementation, the key point detection result is determined by using a key point detector; and the key point detector is trained using a second image and key point label information of the second image, where an object in the second image is distortion-free, and the key point label information is used to describe an actual position of a key point of the object in the second image.

In a possible implementation, the determination unit 402 is specifically used to: determine first abnormal information based on the segmentation result and the three-dimensional model, where the first abnormal information is used to describe differences between a part described by the three-dimensional model and a part described by the segmentation result; and determine the abnormal region in the target image based on the first abnormal information and an anomaly detection result for the target image, where the anomaly detection result is obtained by processing the target image using an anomaly detector, the anomaly detector is trained using a positive sample image, a negative sample image, and anomaly label information of the negative sample image, an object in the positive sample image is distortion-free, an object in the negative sample image exhibits distortion, and the anomaly label information is used to describe an actual position of distortion in the negative sample image.

In a possible implementation, the image restoration apparatus 400 further includes:

a screenshot unit, used to determine a screenshot of at least one region from the target image, where different regions are used to describe different parts of the object in the target image, and the at least one region does not include the abnormal region;

a detection unit, used to perform, for any region within the at least one region, anomaly detection processing on a screenshot of the region to obtain an anomaly detection result for the region; and

an update unit, used to update the abnormal region in the target image based on the anomaly detection result for each region.

Based on the relevant content of the above-mentioned image restoration apparatus 400, it may be inferred that a working principle of the image restoration apparatus 400 provided in this application includes: first acquiring the target image, such as a newly generated image through an AI image generation technology; then, determining the abnormal region in the target image based on the segmentation result for the target image and the three-dimensional model corresponding to the target image, thereby allowing the abnormal region to describe the distortion in the target image; then, occluding the abnormal region in the target image to obtain the occluded image, thereby ensuring that the occluded image contains no or as little distortion as possible; and finally, determining the restoration result for the target image based on the occluded image and the three-dimensional model, thereby ensuring that the restoration result contains no or as little distortion as possible. Accordingly, the image quality can be improved, thereby increasing the yield of high-quality images.

Additionally, an embodiment of this application further provides an electronic device. The device includes a processor and a memory. The memory is configured to store an instruction or a computer program. The processor is configured to execute the instruction or the computer program in the memory to cause the electronic device to perform any implementation of the image restoration method according to the embodiments of this application.

Reference is made to FIG. 5, which illustrates a schematic structural diagram of an electronic device 500 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle-mounted terminal (e.g., a vehicle navigation terminal), and fixed terminals such as a digital TV and a desktop computer. The electronic device shown in FIG. 5 is merely an example, and should not impose any limitation on the function and scope of use of the embodiments of the present disclosure.

As shown in FIG. 5, the electronic device 500 may include a processing apparatus (e.g., a central processing unit and a graphics processing unit) 501, which may perform various suitable actions and processing according to a program stored in a read only memory (ROM) 502 or a program loaded from a storage apparatus 508 into a random-access memory (RAM) 503. The RAM 503 further stores various programs and data needed by the operation of the electronic device 500. The processing apparatus 501, the ROM 502, and the RAM 503 are connected to one another through a bus 504. An input/output (I/O) interface 505 is also connected to the bus 504.

Typically, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a magnetic tape and a hard drive; and a communication apparatus 509. The communication apparatus 509 may allow the electronic device 500 to be in wireless or wired communication with other devices for data exchange. Although FIG. 5 illustrates the electronic device 500 having various apparatuses, it should be understood that it is not required to implement or have all of the shown apparatuses. It may be an alternative to implement or have more or fewer apparatuses.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication apparatus 509, or installed from the storage apparatus 508, or installed from the ROM 502. When the computer program is executed by the processing apparatus 501, the above-mentioned functions defined in the method of the embodiment of the present disclosure are performed.

The electronic device according to this embodiment of the present disclosure and the method according to the above-mentioned embodiments belong to the same inventive concept. For the technical details not exhaustively described in this embodiment, reference may be made to the above-mentioned embodiments, and this embodiment and the above-mentioned embodiments have the same beneficial effects.

An embodiment of this application also provides a computer-readable medium, having an instruction or a computer program stored therein. The instruction or the computer program, when running on a device, causes the device to perform any one of implementations of the image restoration method according to the embodiments of this application.

It should be noted that the above-mentioned computer-readable medium in the present disclosure may be either a computer-readable signal medium or a computer-readable storage medium, or any combination of the two. The computer-readable storage medium may be, for example but is not limited to, electric, magnetic, optical, electromagnetic, infrared, or semiconductor systems, apparatuses, or devices, or any combination thereof. More specific examples of the computer-readable storage medium may include, but are not limited to: an electrical connection with one or more wires, a portable computer disk, a hard drive, a random-access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to, an electromagnetic signal, an optical signal, or any suitable combination of the above. The computer-readable signal medium may further be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and the server may communicate using any currently known or future-developed network protocols such as a hypertext transfer protocol (HTTP), and may also be interconnected with digital data communication in any form or medium (e.g., a communication network). Examples of the communication network include a local area network ("LAN"), a wide area network ("WAN"), Internet work (e.g., Internet), a peer-to-peer network (e.g., an ad hoc peer-to-peer network), and any currently known or future-developed networks.

The above-mentioned computer-readable medium may be included in the above-mentioned electronic device; or may also separately exist without being assembled in the electronic device.

The above-mentioned computer-readable medium carries one or more programs. The above-mentioned one or more programs, when executed by the electronic device, cause the electronic device to perform the above-mentioned method.

Computer program code for performing operations of the present disclosure may be written in one or more programming languages or a combination thereof, where the above-mentioned programming languages include, but are not limited to, object-oriented programming languages, such as Java, Smalltalk, and C++, and further include conventional procedural programming languages, such as "C" language or similar programming languages. The program code may be completely executed on a user computer, partially executed on the user computer, executed as a stand-alone software package, partially executed on the user computer and partially executed on a remote computer, or completely executed on the remote computer or the server. In the case of the remote computer, the remote computer may be connected to the user computer through any kind of network, including a local area network (LAN) or a wide area network (WAN), or may be connected to an external computer (e.g., connected through the Internet with the aid of an Internet service provider).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may be performed substantially in parallel, but sometimes may also be performed in a reverse order, depending on involved functions. It should also be noted that each block in the block diagrams and/or the flowcharts, and a combination of the blocks in the block diagrams and/or the flowcharts may be implemented using a dedicated hardware-based system that performs specified functions or operations, or may be implemented using a combination of dedicated hardware and computer instructions.

The involved units described in the embodiments of the present disclosure may be implemented through software or hardware. The name of the unit/module does not constitute a limitation on the unit itself under certain circumstances.

Herein, the functions described above may be performed at least partially by one or more hardware logic components. For example, without limitation, exemplary hardware logic components that can be used include: a field-programmable gate array (FPGA), an application-specific integrated circuit (ASIC), an application-specific standard product (ASSP), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above-mentioned content. More specific examples of the machine-readable storage medium may include an electrical connection based on one or more wires, a portable computer disk, a hard drive, a random-access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above-mentioned content.

It should be noted that the various embodiments in the specification are described in a progressive manner, highlighting the differences between each embodiment and the other embodiments. The similar or identical parts between different embodiments may be cross-referenced to each other. For the system or the apparatus disclosed in the embodiments, since it corresponds to the method disclosed in the embodiments, the description is relatively simple, and for the related parts, reference may be made to the partial description of the method.

It should be understood that in this application, "at least one" refers to one or more, and "a plurality of" refers to two or more. The term "and/or" is an association relationship for describing associated objects, indicating that there may be three relationships. For example, "A and/or B" may represent three situations: A exists alone, B exists alone, and both A and B exist, where A and B may be singular or plural. The character "/" generally indicates an "or" relationship between preceding and succeeding associated objects. "At least one of the following items" or similar expressions refer to any combination of these items, including any combination of single or plural items. For example, at least one of a, b, or c may represent: a, b, c, "a and b", "a and c", "b and c", or "a, b, and c", where a, b, and c may be single or plural.

It should be further noted that herein, relational terms such as first and second are used only to distinguish one entity or operation from another and do not necessarily require or imply any actual relationship or order between these entities or operations. In addition, the terms "comprise", "include", or any other variations thereof are intended to cover non-exclusive inclusions, and therefore a process, a method, an article, or a device including a series of elements not only includes those elements but also includes other elements not clearly listed, or further includes elements inherent to the process, the method, the article, or the device. In the absence of more restrictions, an element defined by "including/comprising a/an …" does not exclude another identical element in the process, the method, the article, or the device that includes the element.

The steps of the method or the algorithm described in combination with the embodiments disclosed herein may be implemented directly in hardware, in a software module executed by a processor, or in a combination of the two. The software module may be arranged in a random-access memory (RAM), an internal memory, a read only memory (ROM), an electrically programmable ROM, an electrically erasable programmable ROM, a register, a hard drive, a removable disk, a CD-ROM, or any other form of storage medium known in the art.

Those skilled in the art can implement or use this application according to the above-mentioned descriptions of the disclosed embodiments. Various modifications to these embodiments are apparent to those skilled in the art, and the general principle defined herein may be implemented in other embodiments without departing from the spirit or scope of this application. Therefore, this application will not be limited to the embodiments shown herein but needs to conform to a widest scope consistent to the principles and novel characteristics disclosed herein.

I/We Claim:

1. An image restoration method, comprising:
acquiring a target image;
determining an abnormal region in the target image based on a segmentation result for the target image and a three-dimensional model corresponding to the target image, the segmentation result being used to describe positions of respective parts of an object in the target image, driving parameters of the three-dimensional model being determined based on the target image, an object described by the three -dimensional model being free of distortion, and the abnormal region being used to describe distortion in the target image;
occluding the abnormal region in the target image to obtain an occluded image; and
determining a restoration result for the target image based on the occluded image and the three-dimensional model.

2. The method according to claim 1, wherein determining the abnormal region comprises:
projecting the three-dimensional model to an image space of the target image to obtain a two-dimensional image, wherein the two-dimensional image is used to describe a state of the object described by the three-dimensional model in a two-dimensional space;
comparing a segmentation result for the two-dimensional image with the segmentation result for the target image to obtain a comparison result, wherein the comparison result is used to describe a difference between an object in the two-dimensional image and the object in the target image; and
determining the abnormal region in the target image based on the comparison result.

3. The method according to claim 1, wherein determining the restoration result for the target image based on the occluded image and the three-dimensional model comprises:
determining the restoration result for the target image based on the occluded image, the three-dimensional model, and a key point detection result for the target image, wherein the key point detection result is used to describe a pose of the object in the target image.

4. The method according to claim 3, wherein determining the restoration result comprises:
projecting the three-dimensional model to an image space of the target image to obtain a two-dimensional image; and
determining the restoration result for the target image based on the occluded image, the two-dimensional image, and the key point detection result.

5. The method according to claim 4, wherein the restoration result is determined by using an image restoration model;
the image restoration model comprises a first encoding module, a second encoding module, a first network, a second network, and a decoder;
the first encoding module is used to acquire a feature extraction result for the key point detection result, the feature extraction result for the key point detection result is used to represent first information carried by the key point detection result, and the first information comprises a pose;
the second encoding module is used to acquire a feature extraction result for the two-dimensional image, the feature extraction result for the two-dimensional image is used to represent second information carried by the two-dimensional image, and the second information comprises a body shape and a body structure;
the first network is used to determine image features of the occluded image based on an image encoding result and a semantic feature extraction result for the occluded image;
the second network is used to perform denoising processing based on the semantic feature extraction result for the occluded image, the image features of the occluded image, the feature extraction result for the two-dimensional image, the feature extraction result for the key point detection result, and randomly generated noise data, to obtain a denoising result; and
the decoder is used to decode the denoising result to obtain the restoration result for the target image.

6. The method according to claim 3, wherein the restoration result is determined by using an image restoration model; and
a process of training the image restoration model comprises:
acquiring a first image, wherein an object in the first image is free of distortion;
randomly selecting a region from the first image for occlusion, to obtain a region occlusion result;
determining a restoration result for the first image based on the image restoration model, the region occlusion result, a three-dimensional model corresponding to the first image, and a key point detection result for the first image; and
updating a portion of networks in the image restoration model based on a difference between the restoration result for the first image and the first image, wherein the portion of the networks comprise a first encoding module, a second encoding module, a first network, and a second network.

7. The method according to claim 1, wherein determining the abnormal region comprises:
determining first abnormal information based on the segmentation result and the three-dimensional model, and determining second abnormal information based on the segmentation result and a key point detection result for the target image, wherein the first abnormal information is used to describe a difference between a part described by the three-dimensional model and a part described by the segmentation result, and the second abnormal information is used to describe a difference between a part described by the key point detection result and the part described by the segmentation result; and
determining the abnormal region in the target image based on the first abnormal information and the second abnormal information.

8. The method according to claim 3, wherein the key point detection result is determined by using a key point detector; and
the key point detector is trained by using a second image and key point label information of the second image, an object in the second image is free of distortion, and the key point label information is used to describe an actual position of a key point of the object in the second image.

9. The method according to claim 1, wherein determining the abnormal region comprises:
determining first abnormal information based on the segmentation result and the three-dimensional model, wherein the first abnormal information is used to describe a difference between a part described by the three-dimensional model and a part described by the segmentation result; and
determining the abnormal region in the target image based on the first abnormal information and an anomaly detection result for the target image, wherein the anomaly detection result is obtained by processing the target image using an anomaly detector, the anomaly detector is trained by using a positive sample image, a negative sample image, and anomaly label information of the negative sample image, an object in the positive sample image is free of distortion, an object in the negative sample image exhibits distortion, and the anomaly label information is used to describe an actual position of distortion in the negative sample image.

10. The method according to claim 1, wherein after determining the abnormal region in the target image, the method further comprises:
determining a screenshot of at least one region from the target image, wherein different region are used to describe different parts of the object in the target image, and the at least one region does not comprise the abnormal region;
for any region within the at least one region, performing anomaly detection processing on the screenshot of the region to obtain an anomaly detection result for the region; and
updating the abnormal region in the target image based on the anomaly detection result for respective regions.

11. An electronic device, wherein the device comprises a processor and a memory;
the memory is configured to store an instruction or a computer program; and
the processor is configured to execute the instruction or the computer program in the memory, and the instruction or the computer program, when executed by the processor, causes the electronic device to:
acquire a target image;
determine an abnormal region in the target image based on a segmentation result for the target image and a three-dimensional model corresponding to the target image, the segmentation result being used to describe positions of respective parts of an object in the target image, driving parameters of the three-dimensional model being determined based on the target image, an object described by the three -dimensional model being free of distortion, and the abnormal region being used to describe distortion in the target image;
occlude the abnormal region in the target image to obtain an occluded image; and
determine a restoration result for the target image based on the occluded image and the three-dimensional model.

12. The electronic device according to claim 11, wherein the instruction or the computer program causing the electronic device to determine the abnormal region further causes the electronic device to:
project the three-dimensional model to an image space of the target image to obtain a two-dimensional image, wherein the two-dimensional image is used to describe a state of the object described by the three-dimensional model in a two-dimensional space;
compare a segmentation result for the two-dimensional image with the segmentation result for the target image to obtain a comparison result, wherein the comparison result is used to describe a difference between an object in the two-dimensional image and the object in the target image; and
determine the abnormal region in the target image based on the comparison result.

13. The electronic device according to claim 11, wherein the instruction or the computer program causing the electronic device to determine the restoration result for the target image based on the occluded image and the three-dimensional model further causes the electronic device to:
determine the restoration result for the target image based on the occluded image, the three-dimensional model, and a key point detection result for the target image, wherein the key point detection result is used to describe a pose of the object in the target image.

14. The electronic device according to claim 13, wherein the instruction or the computer program causing the electronic device to determine the restoration result further causes the electronic device to:
project the three-dimensional model to an image space of the target image to obtain a two-dimensional image; and
determine the restoration result for the target image based on the occluded image, the two-dimensional image, and the key point detection result.

15. The electronic device according to claim 14, wherein the restoration result is determined by using an image restoration model;
the image restoration model comprises a first encoding module, a second encoding module, a first network, a second network, and a decoder;
the first encoding module is used to acquire a feature extraction result for the key point detection result, the feature extraction result for the key point detection result is used to represent first information carried by the key point detection result, and the first information comprises a pose;
the second encoding module is used to acquire a feature extraction result for the two-dimensional image, the feature extraction result for the two-dimensional image is used to represent second information carried by the two-dimensional image, and the second information comprises a body shape and a body structure;
the first network is used to determine image features of the occluded image based on an image encoding result and a semantic feature extraction result for the occluded image;
the second network is used to perform denoising processing based on the semantic feature extraction result for the occluded image, the image features of the occluded image, the feature extraction result for the two-dimensional image, the feature extraction result for the key point detection result, and randomly generated noise data, to obtain a denoising result; and
the decoder is used to decode the denoising result to obtain the restoration result for the target image.

16. The electronic device according to claim 13, wherein the restoration result is determined by using an image restoration model; and
to train the image restoration model, the instruction or the computer program causes the electronic device to:
acquire a first image, wherein an object in the first image is free of distortion;
randomly select a region from the first image for occlusion, to obtain a region occlusion result;
determine a restoration result for the first image based on the image restoration model, the region occlusion result, a three-dimensional model corresponding to the first image, and a key point detection result for the first image; and
update a portion of networks in the image restoration model based on a difference between the restoration result for the first image and the first image, wherein the portion of the networks comprise a first encoding module, a second encoding module, a first network, and a second network.

17. The electronic device according to claim 11, wherein the instruction or the computer program causing the electronic device to determine the abnormal region further causes the electronic device to:
determine first abnormal information based on the segmentation result and the three-dimensional model, and determine second abnormal information based on the segmentation result and a key point detection result for the target image, wherein the first abnormal information is used to describe a difference between a part described by the three-dimensional model and a part described by the segmentation result, and the second abnormal information is used to describe a difference between a part described by the key point detection result and the part described by the segmentation result; and
determine the abnormal region in the target image based on the first abnormal information and the second abnormal information.

18. The electronic device according to claim 13, wherein the key point detection result is determined by using a key point detector; and
the key point detector is trained by using a second image and key point label information of the second image, an object in the second image is free of distortion, and the key point label information is used to describe an actual position of a key point of the object in the second image.

19. The electronic device according to claim 11, wherein the instruction or the computer program causing the electronic device to determine the abnormal region further causes the electronic device to:
determine first abnormal information based on the segmentation result and the three-dimensional model, wherein the first abnormal information is used to describe a difference between a part described by the three-dimensional model and a part described by the segmentation result; and
determine the abnormal region in the target image based on the first abnormal information and an anomaly detection result for the target image, wherein the anomaly detection result is obtained by processing the target image using an anomaly detector, the anomaly detector is trained by using a positive sample image, a negative sample image, and anomaly label information of the negative sample image, an object in the positive sample image is free of distortion, an object in the negative sample image exhibits distortion, and the anomaly label information is used to describe an actual position of distortion in the negative sample image.

20. A non-transitory computer-readable medium, having an instruction or a computer program stored therein, wherein the instruction or the computer program, when running on a device, causes the device to:
acquire a target image;
determine an abnormal region in the target image based on a segmentation result for the target image and a three-dimensional model corresponding to the target image, the segmentation result being used to describe positions of respective parts of an object in the target image, driving parameters of the three-dimensional model being determined based on the target image, an object described by the three -dimensional model being free of distortion, and the abnormal region being used to describe distortion in the target image;
occlude the abnormal region in the target image to obtain an occluded image; and
determine a restoration result for the target image based on the occluded image and the three-dimensional model.
